(19) United States
(12) Patent Application Publication
(10) Pub. No.: US 2012/0016773 A1
(43) Pub. Date: Jan. 19, 2012

(54) Customizable Method and System for Determining a Preliminary Cost Estimate for a Home Renovation Project

(76) Inventor: Steven D. Strauss, Whitehall, PA (US)

(21) Appl. No.: 12/838,530

(22) Filed: Jul. 19, 2010

(51) Int. Cl. G06Q 30/00

(52) U.S. Cl. 705/27.1

(57) ABSTRACT

A method and system for providing a preliminary cost estimate for a renovation project for a room in a home such as a kitchen or a bathroom is disclosed and claimed. The method includes the steps of a user inputting into a computer system, information regarding a room layout most closely resembling that of a potential customer. The user may also input general categories selected by the customer regarding cabinet door styles, cabinet construction and finish, countertop materials, and floor materials. The user may also input the potential customer's selections regarding faucet styles, appliance packages, and backsplash styles. In response, the computer system produces a report based upon the potential customer's selections. The report contains a description of materials needed to complete the project as well as an estimate of total cost to complete the project.

### FIELD OF INVENTION

The present invention relates to project estimation using a computer or similar processing device. More particularly, this invention relates to a customizable method and system for determining a preliminary cost estimate for a home renovation project, such as for a kitchen or bathroom renovation.

### BACKGROUND OF THE INVENTION

In projects involving the renovation of rooms within homes such as kitchens and bathrooms, designing the room and selecting the cabinetry, countertops, flooring, equipment, and appliances to be installed in the room is often complicated and time-consuming. Dealers involved in the retail sale of such products, often become involved with customers in the room design process and offer assistance in making product choices. Such dealers are often referred to as certified kitchen designers (CKD). The dealer, serving in the role of kitchen or bathroom designer, may often invest considerable amounts of time and effort in designing such a room and arriving at a precise cost estimate for the renovation project, only to find that the estimate is well beyond the customer's budget, or that the customer has no budget, and the project is prohibitively expensive.

To arrive at a precise estimate, the dealer may visit the customer at home, take measurements of the existing kitchen or bathroom layout, and personally interview the customer to determine preferences with respect to kitchen or bathroom cabinetry, countertops, flooring, appliances, etc. Often these preferences are determined based upon the customer selecting among a myriad of choices presented by the dealer which can be quite time consuming. Often, the customer can be dissatisfied or disappointed with the project estimate, as it may be well beyond the customer's budget. Often, to avoid losing the business entirely, the dealer will spend considerable additional time attempting to adjust the project estimate to bring it within the customer's budget, so the invested time is not lost.

Currently, no software or method exists for enabling a dealer and potential customer to arrive at a quick room renovation project estimate that requires little effort spent. By providing a means for quickly determining a cost estimate for such a project, the dealer can begin to qualify the prospective customer. That is, the dealer can begin to determine whether that customer is qualified to buy from him or her. Through qualifying, the dealer can ensure that the prospective customer is an appropriate person to sell to, i.e., that the prospective customer has the money and motivation to hire the dealer to complete the project. Many customers want things they cannot afford, or have unrealistic budgets. Qualifying ensures that a prospective customer will make a good customer and will save the dealer and customer a significant amount of time.

If the dealer determines that the customer is qualified, then the dealer may find it appropriate to invest the added time and effort necessary to do the exact figuring needed to arrive at a final project estimate.

### SUMMARY OF THE INVENTION

A method and system for providing a preliminary cost estimate for a renovation project for a room in a home such as a kitchen or a bathroom is disclosed and claimed. The method includes the steps of a user, e.g., a dealer, inputting into a computer system, information regarding a room layout most closely resembling that of a potential customer. The user may also input general categories selected by the customer regarding cabinet door styles, cabinet construction and finish, countertop materials, and floor materials. The user may also input the potential customer's selections regarding faucet styles, appliance packages, and backsplash styles. In response, the computer system produces a report based upon the potential customer's selections. The report contains a listing of the general selections made by the user during the foregoing steps which can be printed out, along with an estimate of the total cost to complete the project.

### BRIEF DESCRIPTION OF THE DRAWINGS

FIG. 1 illustrates the hardware associated with the present invention;

FIG. 2A is a portion of an operational flowchart of the present invention;

FIG. 2B is a continuation of the operational flowchart of FIG. 2A; and,

FIG. 2C is a continuation of the operational flowchart of FIG. 2B.

### DETAILED DESCRIPTION OF THE PREFERRED EMBODIMENTS

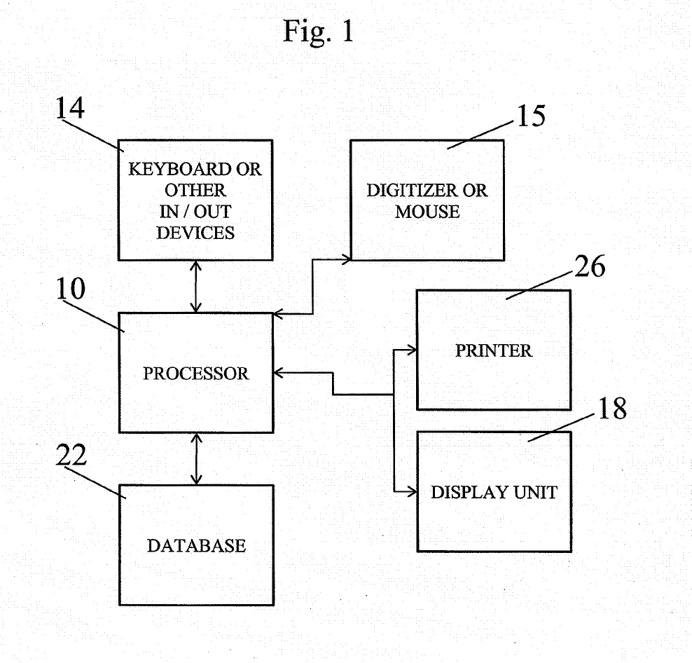

Referring now to FIG. 1, there is shown therein hardware associated with the method and system of the present invention. The hardware, e.g., a computer, basically comprises a processor 10 to interpret and execute instructions, and to send and receive data to all the peripheral devices. A keyboard 14 or other input devices, e.g., a mouse 15, are used for entering and requesting data from the processor 10. A display unit 18 is used as the main output device to view information. A database 22 is used to store and retrieve data. A printer 26 is used as an output device to produce reports and tangible copies of the requested data. The software of the present invention may be written in any suitable programming language, such as Microsoft Excel from Microsoft, Inc. of Redmond, Wash.

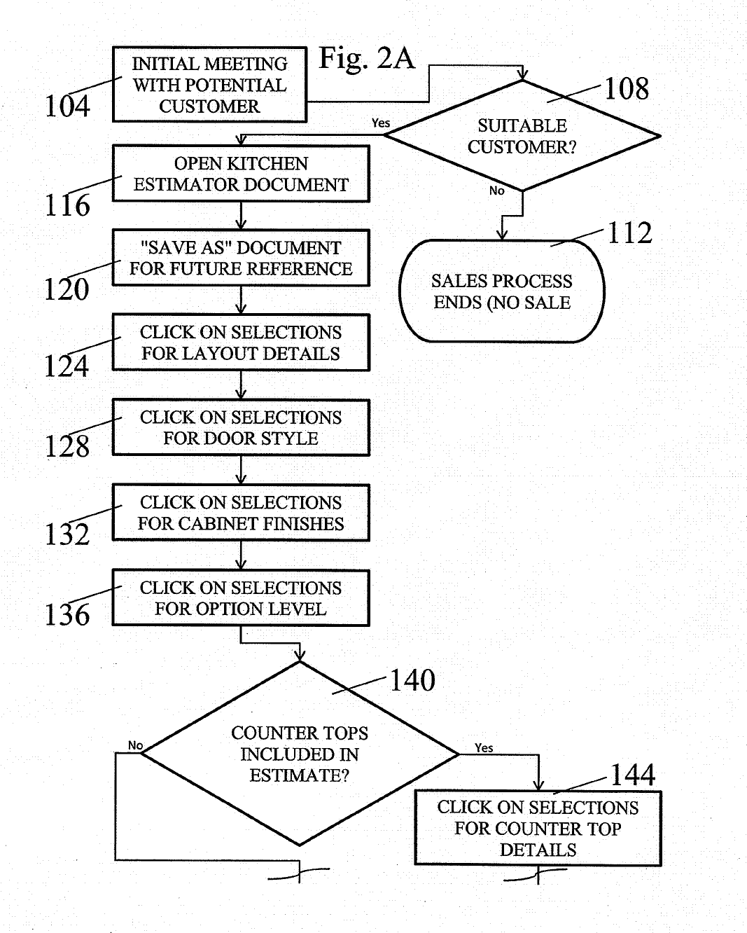

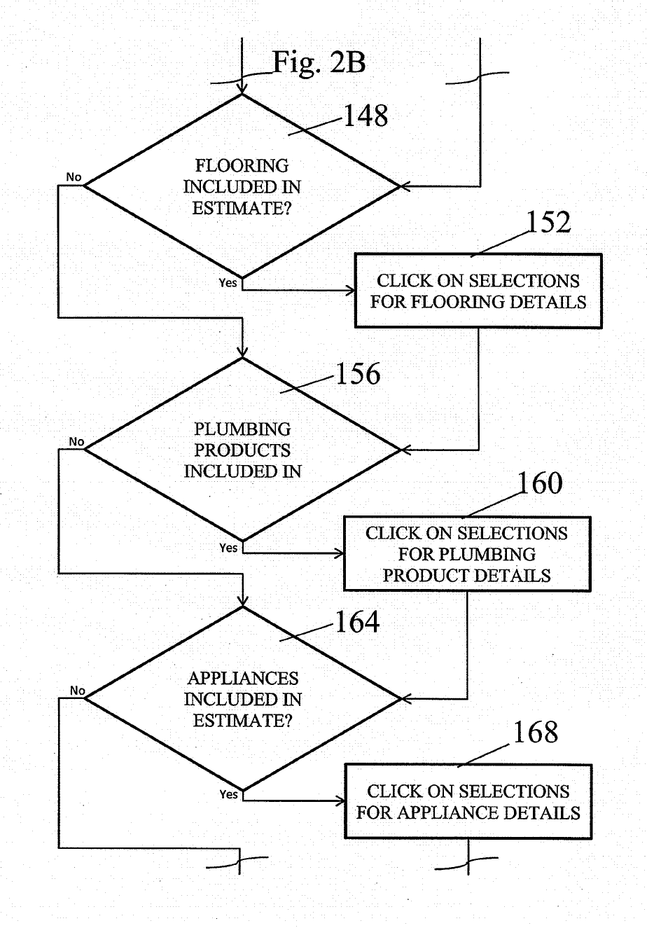

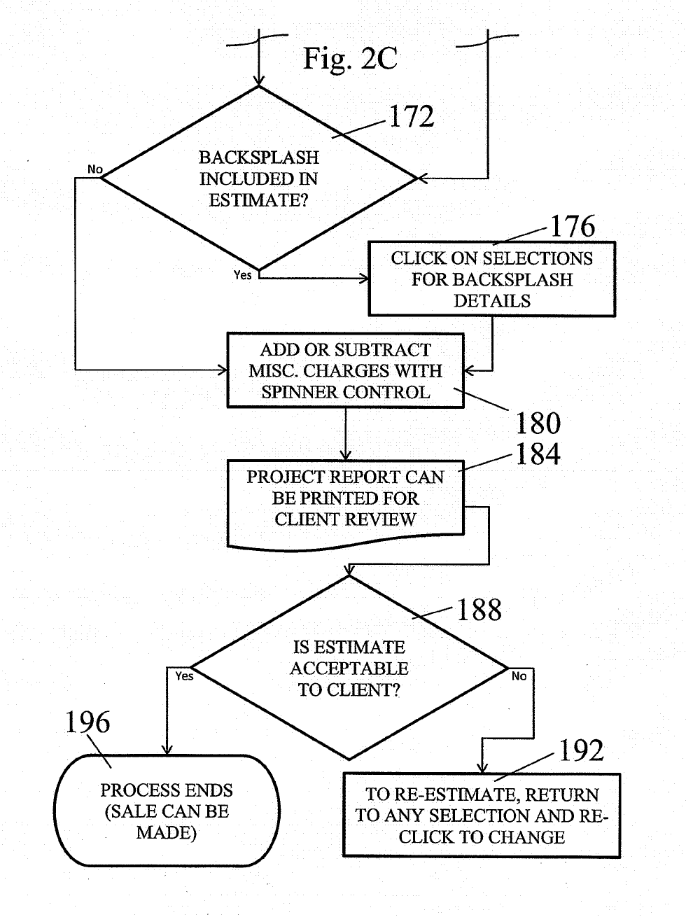

Referring now to FIGS. 2A through 2C, there is shown an operational flowchart describing the method and system of the present invention for determining a preliminary cost estimate for a renovation project. The method and system of the present invention is intended for use by a kitchen and/or bathroom products dealer to enable the dealer to determine whether a prospective customer is an appropriate person to sell to.

As shown at operation block 104 labeled “Initial Meeting with Potential Customer,” the system may be powered on whereby the software initializes itself for operation. During initialization, several housekeeping tasks are performed for the microprocessor that are specific to the type of microprocessor being employed. Next, as shown in FIGS. 2A through 2C, the software flows down to a decision block 108 requesting the user of the software, e.g., the dealer, to determine whether the potential customer is a suitable customer. Such a determination is made based upon answers provided by the potential customer in response to questions asked by the system user. Questions ascertaining whether the potential customer lives within the service area of the dealership, or whether the potential customer owns or rents a home will enable the user to determine whether the potential customer is suitable for selling to.

In the event it is determined that the prospective customer is not suitable, the software flows to the termination symbol indicated at 112, and the sales process ends, with no Project Summary containing a preliminary estimate being provided. If, however, the dealer determines the customer to be suitable, then the software flows to operation block 116 whereby the software enables the user to open a new document to be completed by the user by stepping through the software package and answering a series of questions set forth below. This document will ultimately become the Project Summary setting forth the preliminary estimate. At operation block 120, the software enables the user to save the Project Summary to the database 22.

The software next flows to operation block 124 wherein the user is presented with a screen on the display unit 18 and is asked by the software to “choose the layout that most closely matches that of your kitchen.” The screen presents the user with images of a variety of kitchen layouts to choose from, some being smaller and with fewer features, others being larger and with more elaborate and complex features. Once the user has selected the kitchen layout most closely resembling the kitchen layout of the potential customer, the software flows to operation block 128 wherein the software presents a screen on the display unit 18 showing numerous cabinet door styles, some being less complex and inexpensive, others being more complex and more expensive.

The cabinet door styles are grouped into a plurality of different levels, e.g., seven levels, based upon price. Generally speaking, styles falling within the higher levels are more complex and expensive than styles falling within the lower levels. For example, “Level I” includes a group of the simplest and least expensive cabinet door styles. As the levels go up from Level I through Level VII, for example, the complexity of cabinet doors styles increases, as do the prices. For purposes of providing a preliminary estimate, each level is assigned a price range reflecting the price of the styles within that level. At this juncture, the software does not require the potential customer to select the specific door style he or she prefers for the renovation project, as this could be rather time consuming and unnecessary for obtaining a preliminary estimate. Rather, for purposes of determining a preliminary estimate, the software requests that the customer choose one of the door style levels. As set forth in this example, the user would choose one of seven different door style levels, each level having a price range assigned to it. In this manner, time is saved.

Once the user has selected a cabinet door style level, the software flows to operation block 132 wherein the user is presented with a screen showing images of different cabinet finish categories, e.g., stain colors, paints, glazes and specialty finishes, each finish category having an associated price range reflective of the finishes within that category. The user is asked to input the potential customer's chosen finish category as opposed to the precise finish, thus saving time. Once the finish category has been selected, the software flows to operation block 136 wherein the user is presented with a screen asking the user to select among several, e.g., four, different cabinet construction categories, each of which is described on the screen. For purposes of example, the screen may show four different cabinet construction categories in order of ascending price range, e.g., the “Standard” category, the “Select” category, the “Preferred” category, or the “Unique” category. Each of the foregoing categories provides many options within that category. As mentioned above, to arrive at a preliminary estimate, it is not necessary for the customer to make all of the various choices offered within each category. Rather, to arrive at the preliminary estimate, all that is necessary is for the potential customer to choose one of the cabinet construction categories. As set forth in the foregoing example, the user would be choosing one of the following categories: Standard, Select, Preferred, or Unique. Also, it should be understood that the software is readily customizable to add, remove, or change categories, based upon a dealer's preference. For example, a kitchen dealer that only offers high end kitchen products may choose to eliminate the “Standard” category and add luxury items within more expensive categories. Likewise, the options described within each category may be increased, decreased, or edited to match the mix of goods offered by a particular dealer.

For example, at the “Standard” level, the screen describes cabinet construction as including a solid wood frame, wood dovetailed drawers with undermount slides, furniture board cabinet sides, adjustable shelves, easy-to-clean laminate interiors. At the “Standard” level, the screen describes the cabinet as including options such as all drawer base cabinet, sink base tilt front, lazy susan base cabinet, valence over window, diagonal corner wall cabinet, traditional moulding, matching toe kick, large selection of door hardware, and lifetime warranty on drawer guides and door hinge.

At the “Select” level, the screen describes the cabinet construction as including all “Standard” features plus full extension undermount soft close drawer guides. The screen also describes the cabinet as including all the “Standard” options as well as a large selection of crown and decorative mouldings, roll out base shelves, waste basket roll out, tray base cabinet. At the “Preferred” level, the screen describes the cabinet construction as including all the “Select” features plus all wood cabinet sides. The screen also describes the cabinet as incorporating all of the “Select” options as well as including 36″ or 42″ high wall cabinets, 24″ deep cabinet over refrigerator with built in side panels, angled end wall and base cabinet, lazy susan corner wall cabinet, pot and pan drawer base, super susan corner base cabinet, all roll out shelves, many interior options, exterior decorative accents and mouldings, specialty finishes and glazes. At the “Unique” level, the screen describes the cabinet construction as including all “Preferred” options and features plus the highest quality all wood cabinets and a virtually unlimited selection of door styles, woods, colors, and specialty finishes and one-of-a-kind design details.

Once a cabinet construction category has been chosen, the software flows down to a decision block 140 requesting the user to ascertain whether the potential customer would like countertops included in the estimate. In the event it is determined that countertops are not to be included in the estimate, then the software flows to the next decision block 148 (discussed below). If, however, it is determined that countertops are to be included in the estimate, then the software flows to operation block 144 wherein the user is presented with a screen on the display unit 18 and asked to “select a countertop material.” The screen provides categories of countertop materials, e.g., (1) laminates (including a stainless steel sink), (2) solid surface (includes flush sink), and (3) stone including granite and quartz (undermount sink). Each category has a price range associated with it. For example, the price ranges increase as categories go from laminates to solid surfaces to stone. The screen also provides images of various countertop materials within each category to assist the potential customer in selecting a category. As mentioned previously, it should be understood that countertop options provided under each category and categories themselves can be adjusted to match the mix of countertop materials offered by a particular dealer.

Once a countertop material category has been selected (or bypassed), the software flows down to decision block 148 (FIG. 2B) requesting the user to ascertain whether the potential customer would like flooring included in the estimate. In the event it is determined that flooring is to be included in the estimate, then at operation block 152, the user is presented with a screen asking the user to “select a floor material.” The screen also presents images of different flooring materials organized under different categories, e.g., vinyl, laminate, luxury tile, cork, ceramic/porcelain tile, or wood, etc., each category having a price range associated with it, some price ranges being higher than others depending upon the flooring material category selected. As discussed earlier, the images of flooring material provided under each category, as well as the categories themselves may be adjusted to match the mix of flooring materials offered by a particular dealer.

Once a flooring material category has been selected (or bypassed), the software flows down to decision block 156 requesting the user to ascertain whether the potential customer would like plumbing, e.g., faucets, included in the estimate. In the event it is determined that plumbing is to be included in the estimate, then at operation block 160, the user is presented with a screen requesting the user to “select a faucet style.” The screen also presents images of different faucet styles, for example, each having a price associated with it; prices for designer faucets being higher than for standard faucets. As already mentioned, the images of faucets or other plumbing products may be adjusted to match the mix of plumbing products offered by a particular dealer.

Once a plumbing product has been selected (or bypassed), the software flows down to decision block 164 requesting the user to ascertain whether the potential customer would like an appliance package. An appliance package could be a combination of different appliance products bundled in combination to include for example a refrigerator, a range, a microwave, a dishwashwer, etc. More expensive appliance packages may include luxury appliance such as a wine refrigerator. If it is determined that an appliance package is to be included in the estimate, then at operation block 168, the user is presented with a screen requesting the user to “select an appliance package.” The screen also presents images of different appliance packages, each having a price range associated with it, the price range for luxury appliance packages being higher than for standard appliance packages. As discussed earlier, the images of appliances provided under each appliance package, as well as the packages to be included in the estimate can be adjusted to match the mix of appliances the particular dealer offers for sale.

Once an appliance package has been selected (or bypassed), the software flows down to decision block 172 (FIG. 2C) requesting the user to ascertain whether the potential customer would like a backsplash included in the estimate. If it is determined that a backsplash is to be included in the estimate, then at operation block 176, the user is presented with a screen requesting the user to “select the look of the tile backsplash you would like.” The screen also presents images of different backsplash styles organized under different categories, e.g., straight tile, metal, tile with decos and inserts, mural tiles, etc., each category having a price range associated with it, some price ranges being higher than others depending upon the backsplash style selected. As discussed earlier, the choices and images of backsplash styles provided under each category, as well as the categories themselves, may be adjusted to match the mix of flooring materials offered by a particular dealer.

Once a backsplash style has been selected (or bypassed), the software flows down to operation block 180 which enables the user to add or subtract miscellaneous charges for additional products to be included in the renovation project. The charges may be added by utilizing a spinner control, i.e., a graphical control that allows the user to increment or decrement a value using a mouse instead of a keyboard. Once any miscellaneous charges have been added or subtracted, the software flows down to document block 184 wherein the Project Report can be generated and printed and reviewed by the potential customer. The Project Report may include customer information such as the customer's name and address. It may also include a list of the choices selected by the customer and includes a preliminary estimate for the room renovation, along with a description as to what labor is included in the estimate and what labor is excluded. The cost estimate is calculated by adding the cost for the various items selected by the user.

As indicated in decision block 188 and operation block 192, in the event the estimate is not acceptable, e.g., it is outside the potential customer's budget, the user can return to any selection previously made and adjust that selection to bring the estimate within the potential customer's budget. In the event the estimate is acceptable to the customer, as indicated at termination block 196, the process comes to an end, the sale can be made, and the design and renovation work can begin.

While various embodiments have been shown and described, various modifications and substitutions may be made thereto without departing from the spirit and scope of the invention. For example, although the method and system of the present invention has been described in connection with providing a preliminary cost estimate for a kitchen renovation, it is not intended that the scope of this invention be limited to kitchen renovations, and the present invention could be utilized in connection with other rooms within the home. Accordingly, it is to be understood that the present invention has been described by way of illustrations and not limitation.

I claim:

1. A method for determining a preliminary cost estimate for a renovation project for a room in a home, said method implemented on a computer system having a processor and a database, said database comprising digital images of alternative room layouts, digital images of cabinet door styles arranged in levels based on price, images of cabinet finishes arranged in categories based on price, and cabinet construction categories, said method comprising the steps of:
a. selecting from the database a room layout most closely matching an existing room layout of a potential customer;
b. selecting from the database a level of cabinet door style chosen by the potential customer;
c. selecting from the database a category of cabinet finish chosen by the potential customer;
d. selecting from said database a category of cabinet construction chosen by the potential customer; and,
e. processing said selections and producing a report based upon said selections, the report containing a preliminary cost estimate for the project.

2. The method of claim 1, additionally comprising the step of displaying images of cabinet door styles to the potential customer.

3. The method of claim 1, wherein said cabinet finish category is selected from the group consisting of stains, paints, glazes, and specialty finishes.

4. The method of claim 3, additionally comprising the step of displaying images of cabinet door finishes to the potential customer.

5. The method of claim 1, wherein said database additionally comprises digital images of countertop materials arranged in categories according to price, said method additionally comprising the step of selecting from said database a category of countertop material chosen by the potential customer.

6. The method of claim 5, wherein said countertop material category is selected from the group consisting of a laminate category, a solid surface category, and a stone category.

7. The method of claim 6, additionally comprising the step of displaying images of said countertop materials to the potential customer.

8. The method of claim 1, wherein said database additionally comprises digital images of flooring materials arranged in categories according to price, said method additionally comprising the step of selecting from said database a category of flooring material chosen by the potential customer.

9. The method of claim 8, wherein said flooring material category is selected from the group consisting of a vinyl category, a laminate category, a luxury tile category, a cork category, a ceramic/porcelain tile category, and a wood category.

10. The method of claim 9, additionally comprising the step of displaying images of the flooring materials to the potential customer.

11. The method of claim 1, wherein said database additionally comprises digital images of faucet styles, said method additionally comprising the step of selecting from said database a faucet style chosen by the potential customer.

12. The method of claim 11, wherein the computer system displays images of sample faucet styles to the potential customer.

13. The method of claim 1, wherein said database additionally comprises digital images of appliance packages, said method additionally comprising the step of selecting from said database an appliance package chosen by the potential customer.

14. The method of claim 13, additionally comprising the step of displaying images of alternative appliance packages to the potential customer.

15. The method of claim 1, wherein said database additionally comprises digital images of backsplash styles, said method additionally comprising the step of selecting from said database a backsplash style chosen by the potential customer.

16. The method of claim 15, wherein said backsplash style is selected from the group consisting of metal backsplash tile, tile with decos and inserts, and mural tiles.

17. The method of claim 16, wherein the computer system displays images of different backsplash to the potential customer.

18. The method of claim 1, wherein the computer system displays images of different kitchen layouts.

19. A computer implemented system for determining a preliminary cost estimate for a renovation project for a room in a home, said system comprising:
a. a database stored in a memory comprising digital images of alternative room layouts, digital images of cabinet door styles arranged in levels based on price, images of cabinet finishes arranged in categories based on price, and cabinet construction categories;
b. a processor programmed to prompt a user to select from said database a room layout most closely matching an existing room layout of a potential customer, a level of cabinet door style chosen by the potential customer, a category of cabinet finish chosen by the potential customer, and a category of cabinet construction chosen by the potential customer, said processor also being programmed to process said user selections and produce a report based upon said selections, said report containing a preliminary cost estimate for the project.

20. The computer implemented system of claim 19, wherein said database additionally comprises digital images of countertop materials arranged in categories according to price, and wherein said processor is programmed to prompt a user to select from said database a countertop material chosen by the potential customer.

21. The computer implemented system of claim 20, wherein said database additionally comprises digital images of flooring materials arranged in categories according to price, and wherein said processor is programmed to prompt a user to select from said database a flooring material chosen by the potential customer.

22. The computer implemented system of claim 21, additionally comprising a display unit wherein said system displays images of alternative room layouts, cabinet door styles, cabinet finishes, countertop materials, and flooring materials.
